(19) United States
(12) Patent Application Publication
(10) Pub. No.: US 2024/0327189 A1
(43) Pub. Date: Oct. 3, 2024

(54) INK POURING DEVICE

(71) Applicant: SEIKO EPSON CORPORATION, Tokyo (JP)

(72) Inventor: Yasushi UTSUGI, Shiojiri (JP)

(21) Appl. No.: 18/619,255

(22) Filed: Mar. 28, 2024

(30) Foreign Application Priority Data
Mar. 30, 2023 (JP) 2023-056192

(51) Int. Cl. B67C 3/26; B41J 2/175

(52) U.S. Cl. CPC B67C 3/26; B41J 2/17506

(57) ABSTRACT

An ink pouring device that pours ink into an ink bottle for supplying the ink to an ink tank provided in a printer includes: a coupling portion; and a pouring portion configured to pour the ink into the ink bottle only when a coupling target portion of the ink bottle is fitted into the coupling portion.

The present application is based on, and claims priority from JP Application Serial Number 2023-056192, filed Mar. 30, 2023, the disclosure of which is hereby incorporated by reference herein in its entirety.

### BACKGROUND

### 1. Technical Field

The present disclosure relates to an ink pouring device.

### 2. Related Art

Hitherto, an ink bottle that supplies ink to a printer has been known as disclosed in JP-A-2023-016225.

When ink is supplied to a printer by using an ink bottle as in the related art, an empty ink bottle may be discarded after the ink is supplied to the printer. For this reason, the technology according to the related art has room for improvement in Goal 12 “Ensure sustainable consumption and production patterns” among 17 sustainable development goals (SDGs) adopted by the United Nations General Assembly on Sep. 25, 2015.

### SUMMARY

According to an aspect of the present disclosure, an ink pouring device that pours ink into an ink bottle for supplying the ink to an ink tank provided in a printer includes: a coupling portion; and a pouring portion configured to pour the ink into the ink bottle only when a coupling target portion of the ink bottle is fitted into the coupling portion.

### BRIEF DESCRIPTION OF THE DRAWINGS

FIG. 1 is a block diagram illustrating an example of a configuration of an ink management system according to an embodiment of the present disclosure.

FIG. 2 is a cross-sectional view for describing an example of a structure of an ink pouring device.

FIG. 3 is a cross-sectional view for describing an example of a structure of a coupled pouring portion.

FIG. 4 is a cross-sectional view for describing an example of a structure of an ink bottle.

FIG. 5 is a cross-sectional view for describing an example of a structure of a coupled pouring portion.

FIG. 6 is a cross-sectional view for describing coupling between the ink pouring device and the ink bottle.

FIG. 7 is a block diagram illustrating an example of a configuration of a control device.

FIG. 8 is a cross-sectional view for describing an example of a structure of a coupled pouring portion according to a first modified example.

FIG. 9 is a cross-sectional view for describing an example of a structure of a coupled pouring portion according to the first modified example.

### DESCRIPTION OF EMBODIMENTS

Hereinafter, embodiments for carrying out the present disclosure will be described with reference to the drawings. However, the dimensions and scale of each portion are appropriately different from the actual ones in the drawings. Furthermore, since the embodiments described below are suitable specific examples of the present disclosure, various technically favorable limitations are attached thereto. However, the scope of the present disclosure is not limited to the embodiments unless expressly stated otherwise in the following description, particularly limiting the present disclosure.

### A. EMBODIMENT

In the present embodiment, an ink management system Sys that manages a status of supply of ink IK to an ink jet printer PR that forms an image on recording paper by ejecting the ink IK will be described as an example.

### 1. Overview of Ink Management System

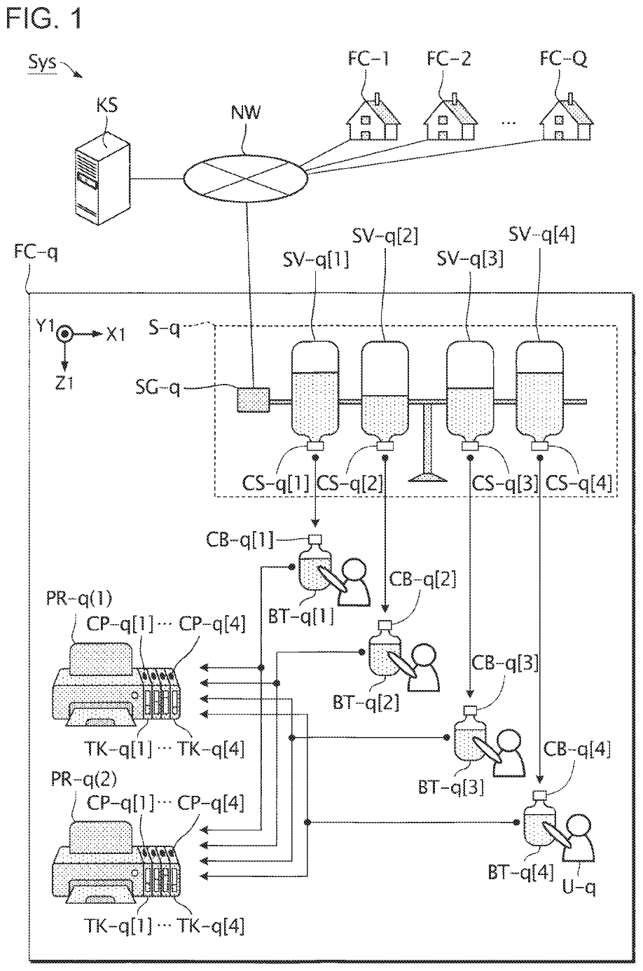

Hereinafter, an example of a configuration of the ink management system Sys according to the present embodiment will be described with reference to FIG. 1.

FIG. 1 is a block diagram illustrating an example of the configuration of the ink management system Sys.

As illustrated in FIG. 1, the ink management system Sys includes a plurality of ink jet printers PR, a plurality of ink storage devices S for storing the ink IK to be supplied to the plurality of ink jet printers PR, a plurality of ink bottles BT for transferring the ink IK stored in the plurality of ink storage devices S to the ink jet printers PR, and a management server KS that manages a storage status of the ink IK in the plurality of ink storage devices S. In the present embodiment, each of the plurality of ink storage devices S can communicate with the management server KS via a network NW that includes one or both of wired and wireless networks.

In the present embodiment, it is assumed that the plurality of ink jet printers PR included in the ink management system Sys are used in a plurality of facilities FC. Here, the facilities FC are facilities where the ink jet printers PR can be used, and examples of the facilities FC include business facilities such as offices and factories, public facilities such as schools and community centers, and private facilities such as residences.

More specifically, in the present embodiment, it is assumed that the plurality of ink jet printers PR included in the ink management system Sys are used in Q facilities FC-1 to FC-Q. Here, the value Q is a natural number satisfying Q≥1. Hereinafter, the q-th facility FC among the Q facilities FC-1 to FC-Q will be referred to as a facility FC-q. Here, the variable q is a natural number satisfying 1≤q≤Q.

Hereinafter, the ink storage device S provided in the facility FC-q will be referred to as an ink storage device S-q, and the ink jet printer PR installed in the facility FC-q will be referred to as an ink jet printer PR-q. When a plurality of ink jet printers PR-q are provided in the facility FC-q, the ink jet printers PR-q are added with suffixes and referred to as an ink jet printer PR-q(1), an ink jet printer PR-q(2), and the like. The example illustrated in FIG. 1 shows a case where two ink jet printers PR-q, the ink jet printer PR-q(1) and the ink jet printer PR-q(2), are provided in the facility FC-q. In the present embodiment, the ink jet printer PR-q is an example of a “printer”.

In the present embodiment, it is assumed that the ink jet printer PR is capable of ejecting M types of ink IK. Here, the value M is a natural number satisfying M≥1. In the present embodiment, as an example, it is assumed that the ink jet printer PR stores four types of ink IK corresponding to cyan, magenta, yellow, and black. That is, in the present embodiment, as an example, it is assumed that “M=4”.

In the present embodiment, it is assumed that the ink jet printer PR includes M ink tanks TK for accommodating M types of ink IK.

Hereinafter, each ink tank TK provided in the ink jet printer PR-q will be referred to as an ink tank TK-q. The m-th ink tank TK among the M ink tanks TK-q provided in the ink jet printer PR-q will be referred to as an ink tank TK-q[m]. Here, the variable m is a natural number satisfying 1≤m≤M.

In the present embodiment, it is assumed that the ink storage device S includes M ink pouring devices SV that correspond one-to-one to M types of ink IK. Each ink pouring device SV accommodates each type of ink IK corresponding thereto.

Hereinafter, each ink pouring device SV provided in the ink storage device S-q will be referred to as an ink pouring device SV-q. The m-th ink pouring device SV among the M ink pouring devices SV-q provided in the ink storage device S-q will be referred to as an ink pouring device SV-q[m].

In the present embodiment, it is assumed that M ink bottles BT that correspond one-to-one to M types of ink IK are arranged in the facility FC-q. Each ink bottle BT accommodates each type of ink IK corresponding thereto.

Hereinafter, each ink bottle BT arranged in the facility FC-q will be referred to as an ink bottle BT-q. The m-th ink bottle BT among the M ink bottles BT arranged in the facility FC-q will be referred to as an ink bottle BT-q[m].

In the present embodiment, when the remaining amount of the ink IK accommodated in the ink tank TK-q[m] among M ink tanks TK-q[1] to TK-q[M] provided in the ink jet printer PR-q is low, a user U-q of the ink jet printer PR-q in the facility FC-q first replenishes the ink bottle BT-q[m] with the ink IK from the ink pouring device SV-q[m] and then replenishes the ink tank TK-q[m] with the ink IK from the ink bottle BT-q[m]. When replenishing the ink bottle BT-q[m] with the ink IK from the ink pouring device SV-q[m], the ink is poured from the ink pouring device SV-q[m] into the ink bottle BT-q[m] by coupling a coupled pouring portion CS-q[m] of the ink pouring device SV-q[m] and a coupled pouring portion CB-q[m] of the ink bottle BT-q[m]. Further, when replenishing the ink tank TK-q[m] with the ink IK from the ink bottle BT-q[m], the ink IK is poured from the ink bottle BT-q[m] into the ink tank TK-q[m] by coupling the coupled pouring portion CB-q[m] of the ink bottle BT-q[m] and a coupled pouring portion CP-q[m] of the ink tank TK-q[m].

Hereinafter, a direction of gravitational acceleration in which the ink IK falls will be referred to as a Z1 direction. The Z1 direction and a Z2 direction opposite to the Z1 direction are collectively referred to as a Z-axis direction, an X1 direction orthogonal to the Z-axis direction and an X2 direction opposite to the X1 direction are collectively referred to as an X-axis direction, and a Y1 direction orthogonal to the Z-axis direction and the X-axis direction and a Y2 direction opposite to the Y1 direction are collectively referred to as a Y-axis direction. In the present embodiment, as an example, it is assumed that the X-axis direction, the Y-axis direction, and the Z-axis direction are directions orthogonal to one another. However, the present disclosure is not limited to such an aspect. It is sufficient that the X-axis direction, the Y-axis direction, and the Z-axis direction be directions intersecting one another.

In the present embodiment, the ink storage device S-q includes a control device SG-q that controls each portion of the ink storage device S-q. The control device SG-q supplies, to the management server KS, ink supply history information DR indicating a history of supply of the ink IK from the ink pouring devices SV-q[1] to SV-q[M] to the ink bottles BT-q[1] to BT-q[M]. Therefore, the management server KS can grasp the remaining amount of each of M types of ink IK accommodated in the ink storage device S-q. The management server KS is an example of a “management device”.

### 2. Overview of Ink Pouring Device and Ink Bottle

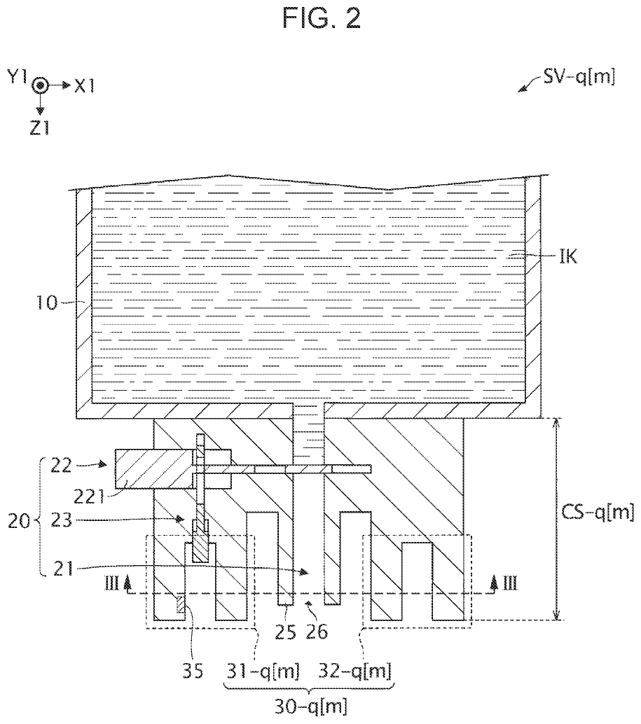

Hereinafter, an example of configurations of the ink pouring device SV-q[m] and the ink bottle BT-q[m] according to the present embodiment will be described with reference to FIGS. 2 to 6.

FIG. 2 is a cross-sectional view illustrating an example of the configuration of the ink pouring device SV-q[m]. Specifically, FIG. 2 is a cross-sectional view of the ink pouring device SV-q[m] when the ink pouring device SV-q[m] is cut along a plane whose normal direction is the Y-axis direction.

As illustrated in FIG. 2, the ink pouring device SV-q[m] includes an ink accommodation portion 10, the coupled pouring portion CS-q[m], and an input terminal 35.

The ink accommodation portion 10 accommodates the ink IK. The ink accommodation portion 10 is an example of an “accommodation portion”. The coupled pouring portion CS-q[m] is provided in the Z1 direction with respect to the ink accommodation portion 10, and includes an ink pouring portion 20 and a coupling portion 30-q[m].

The coupling portion 30-q[m] includes a coupling structure 31-q[m] and a coupling structure 32-q[m].

The ink pouring portion 20 includes an ink supply channel 21, an ink pouring valve 22, and a locking mechanism 23, and when the coupling portion 30-q[m] is coupled to the ink bottle BT-q[m], the ink IK accommodated in the ink accommodation portion 10 is poured into the ink bottle BT-q[m]. The ink pouring portion 20 is an example of a “pouring portion”.

The ink supply channel 21 is a channel formed by a channel structure 25 and extending in the Z1 direction, and is a channel for supplying the ink IK accommodated in the ink accommodation portion 10 to the ink bottle BT-q[m] via an ink pouring port 26 provided at an end portion of the ink supply channel 21 in the Z1 direction. In the present embodiment, the ink supply channel 21 is provided between the coupling structure 31-q[m] and the coupling structure 32-q[m]. In the present embodiment, the ink supply channel 21 is an example of a “supply channel”, the coupling structure 31-q[m] is an example of a “first structure”, and the coupling structure 32-q[m] is an example of a “second structure”.

The ink pouring valve 22 is a mechanism for restricting a flow of the ink IK in the ink supply channel 21. In the present embodiment, the ink pouring valve 22 closes the ink supply channel 21 and stops the flow of the ink IK in the ink supply channel 21 in the Z1 direction when an ink pouring switch 221 is not pressed. When the ink pouring switch 221 is pressed, the ink pouring valve 22 opens the ink supply channel 21 and enables the flow of the ink IK in the ink supply channel 21 in the Z1 direction. FIG. 2 illustrates a case where the ink pouring switch 221 is not pressed, and the ink pouring valve 22 closes the ink supply channel 21.

The locking mechanism 23 is a mechanism for locking the ink pouring valve 22. The locking mechanism 23 locks the ink pouring valve 22 in such a way that the ink pouring switch 221 cannot be pressed when the ink bottle BT-q[m] is not coupled to the coupling portion 30-q[m]. Therefore, in the present embodiment, when the ink bottle BT-q[m] is not coupled to the coupling portion 30-q[m], the ink supply channel 21 is closed by the ink pouring valve 22, and the flow of the ink IK in the ink supply channel 21 in the Z1 direction is stopped. When the ink bottle BT-q[m] is coupled to the coupling portion 30-q[m], the locking mechanism 23 unlocks the ink pouring valve 22 to enable pressing of the ink pouring switch 221. Therefore, in the present embodiment, when the ink bottle BT-q[m] is coupled to the coupling portion 30-q[m], as the ink pouring switch 221 is pressed, the ink pouring valve 22 opens the ink supply channel 21, and the flow of the ink IK in the ink supply channel 21 in the Z1 direction is enabled.

The input terminal 35 is electrically coupled to an output terminal 55 included in the ink bottle BT-q[m] when the ink bottle BT-q[m] is coupled to the coupling portion 30-q[m]. When the ink bottle BT-q[m] is coupled to the coupling portion 30-q[m], an electrical signal is input from the output terminal 55 to the input terminal 35.

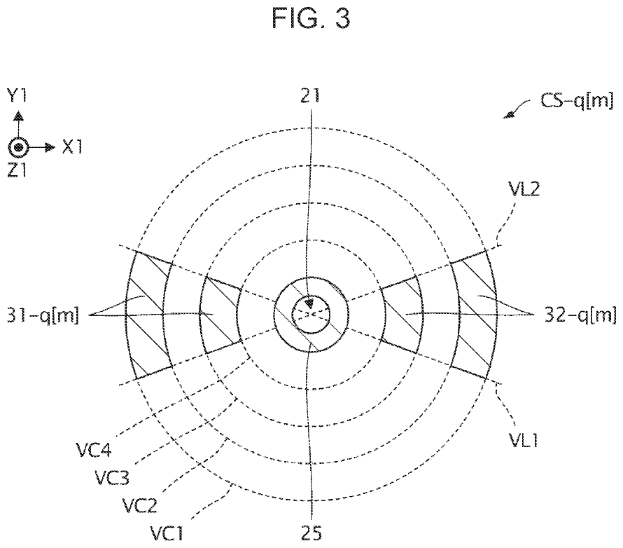

FIG. 3 is a cross-sectional view of the coupled pouring portion CS-q[m] taken along line III-III of FIG. 2 when the coupled pouring portion CS-q[m] is cut along a plane whose normal direction is the Z-axis direction.

As described above, the coupled pouring portion CS-q[m] includes the channel structure 25 in which the ink supply channel 21 is provided, the coupling structure 31-q[m], and the coupling structure 32-q[m].

As illustrated in FIG. 3, the coupling structure 31-q[m] is provided in a region positioned in the Y2 direction with respect to a straight line VL1 and positioned in the Y1 direction with respect to a straight line VL2 between a curve VC1 and a curve VC2, and a region positioned in the Y2 direction with respect to the straight line VL1 and positioned in the Y1 direction with respect to the straight line VL2 between a curve VC3 and a curve VC4 in plan view of the coupled pouring portion CS-q[m] in the Z2 direction.

Here, the curve VC1 is a circular virtual curve positioned outside the channel structure 25 in plan view of the coupled pouring portion CS-q[m] in the Z2 direction. The curve VC2 is a circular virtual curve positioned between the channel structure 25 and the curve VC1 in plan view of the coupled pouring portion CS-q[m] in the Z2 direction. The curve VC3 is a circular virtual curve positioned between the channel structure 25 and the curve VC2 in plan view of the coupled pouring portion CS-q[m] in the Z2 direction. The curve VC4 is a circular virtual curve positioned between the channel structure 25 and the curve VC3 in plan view of the coupled pouring portion CS-q[m] in the Z2 direction. The straight line VL1 is a virtual straight line passing through a position overlapping the ink supply channel 21 and extending in a direction between the X1 direction and the Y2 direction in plan view of the coupled pouring portion CS-q[m] in the Z2 direction. The straight line VL2 is a virtual straight line passing through a position overlapping the ink supply channel 21 and extending in a direction between the X1 direction and the Y1 direction in plan view of the coupled pouring portion CS-q[m] in the Z2 direction.

The coupling structure 32-q[m] is provided in a region positioned in the Y1 direction with respect to the straight line VL1 and positioned in the Y2 direction with respect to the straight line VL2 between the curve VC1 and the curve VC2, and a region positioned in the Y1 direction with respect to the straight line VL1 and positioned in the Y2 direction with respect to the straight line VL2 between the curve VC3 and the curve VC4 in plan view of the coupled pouring portion CS-q[m] in the Z2 direction.

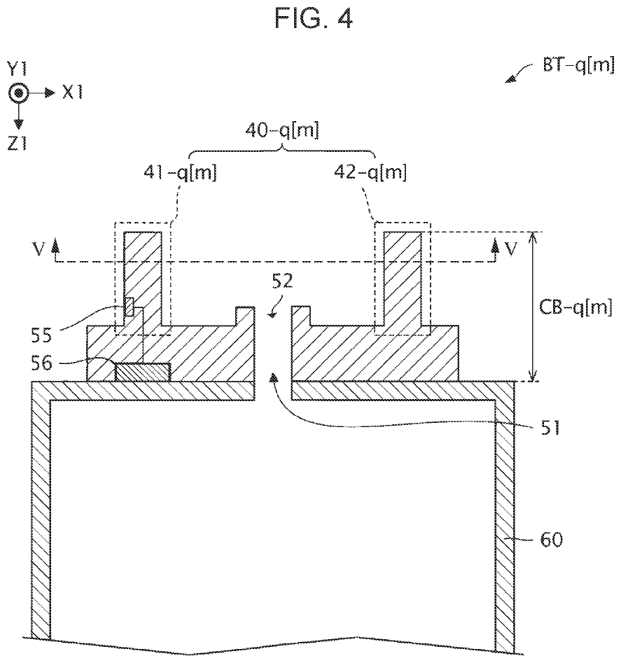

FIG. 4 is a cross-sectional view illustrating an example of the configuration of the ink bottle BT-q[m]. Specifically, FIG. 4 is a cross-sectional view of the ink bottle BT-q[m] arranged in such a way that the coupled pouring portion CB-q[m] faces the Z2 direction when the ink bottle BT-q[m] is cut along a plane whose normal direction is the Y-axis direction.

As illustrated in FIG. 4, the ink bottle BT-q[m] includes an ink accommodation portion 60, the coupled pouring portion CB-q[m], the output terminal 55, and a memory 56.

The ink accommodation portion 60 accommodates the ink IK. The coupled pouring portion CB-q[m] is provided in the Z2 direction with respect to the ink accommodation portion 60, and includes a coupling target portion 40-q[m] and an ink pouring channel 51.

The coupling target portion 40-q[m] includes a coupling structure 41-q[m] and a coupling structure 42-q[m]. In the present embodiment, the ink bottle BT-q[m] is coupled to the ink pouring device SV-q[m] by fitting the coupling target portion 40-q[m] into the coupling portion 30-q[m]. Specifically, the coupling structure 41-q[m] is fitted into the coupling structure 31-q[m], and the coupling structure 42-q[m] is fitted into the coupling structure 32-q[m], thereby coupling the ink bottle BT-q[m] to the ink pouring device SV-q[m]. The ink pouring channel 51 is a channel extending in the Z1 direction, and supplies the ink IK poured from the ink pouring device SV-q[m] to the ink accommodation portion 60. Specifically, when the ink bottle BT-q[m] is coupled to the ink pouring device SV-q[m], and an ink pouring port 52 provided at an end portion of the ink pouring channel 51 in the Z2 direction is coupled to the ink pouring port 26, the ink pouring channel 51 supplies the ink IK poured from the ink pouring port 26 to the ink pouring port 52 to the ink accommodation portion 60.

The memory 56 stores bottle identification information DBI. Here, the bottle identification information DBI is information for identifying each ink bottle BT-q[m] from among the plurality of ink bottles BT included in the ink management system Sys. In the present embodiment, the bottle identification information DBI is an example of “identification information”.

The output terminal 55 is electrically coupled to the input terminal 35 when the ink bottle BT-q[m] is coupled to the ink pouring device SV-q[m], and outputs an electrical signal indicating the bottle identification information DBI stored in the memory 56 to the input terminal 35.

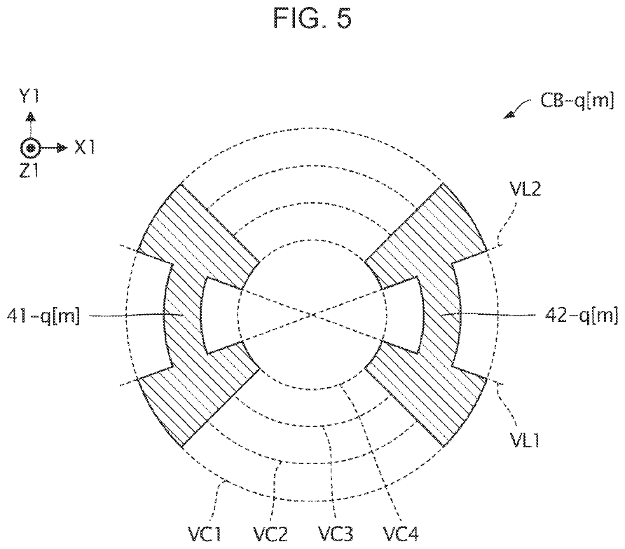

FIG. 5 is a cross-sectional view of the coupled pouring portion CB-q[m] taken along line V-V of FIG. 4 when the coupled pouring portion CB-q[m] is cut along a plane whose normal direction is the Z-axis direction.

As described above, the coupled pouring portion CB-q[m] includes the coupling structure 41-q[m] and the coupling structure 42-q[m].

As illustrated in FIG. 5, the coupling structure 41-q[m] is provided in a left-center region which is a region positioned in the Y2 direction with respect to the straight line VL1 and positioned in the Y1 direction with respect to the straight line VL2 between the curve VC2 and the curve VC3, a region coupled to the left-center region and positioned in the Y1 direction with respect to the straight line VL1 between the curve VC1 and the curve VC3, and a region coupled to the left-center region and positioned in the Y2 direction with respect to the straight line VL2 between the curve VC1 and the curve VC3 in plan view of the coupled pouring portion CB-q[m] in the Z2 direction.

The coupling structure 42-q[m] is provided in a right-center region which is a region positioned in the Y1 direction with respect to the straight line VL1 and positioned in the Y2 direction with respect to the straight line VL2 between the curve VC2 and the curve VC3, a region coupled to the right-center region and positioned in the Y1 direction with respect to the straight line VL2 between the curve VC1 and the curve VC3, and a region coupled to the right-center region and positioned in the Y2 direction with respect to the straight line VL1 between the curve VC1 and the curve VC3 in plan view of the coupled pouring portion CB-q[m] in the Z2 direction.

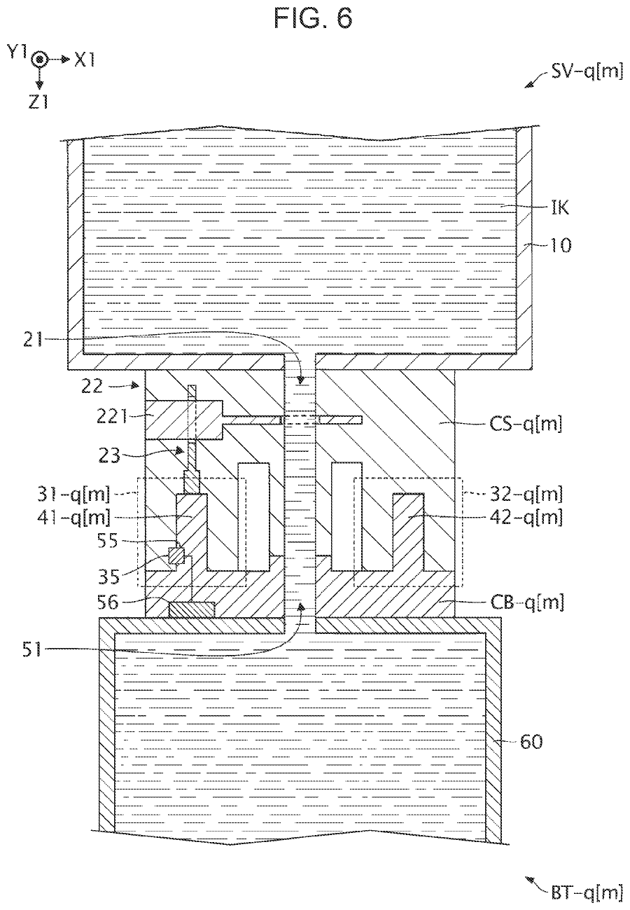

FIG. 6 is a cross-sectional view of the ink pouring device SV-q[m] and the ink bottle BT-q[m] cut along a plane whose normal direction is the Y-axis direction when the ink pouring device SV-q[m] and the ink bottle BT-q[m] are coupled to each other.

As the coupling structure 41-q[m] is fitted into the coupling structure 31-q[m], and the coupling structure 42-q[m] is fitted into the coupling structure 32-q[m] as illustrated in FIG. 6, when the ink pouring device SV-q[m] and the ink bottle BT-q[m] are coupled to each other, the ink pouring valve 22 is unlocked by the locking mechanism 23, and pressing of the ink pouring switch 221 is enabled. Then, when the ink pouring switch 221 is pressed and the ink supply channel 21 is opened by the ink pouring valve 22, the ink supply channel 21 and the ink pouring channel 51 are coupled to each other, and the ink IK is poured from the ink accommodation portion 10 to the ink accommodation portion 60 via the ink supply channel 21 and the ink pouring channel 51.

When the ink pouring device SV-q[m] and the ink bottle BT-q[m] are coupled to each other, the input terminal 35 and the output terminal 55 are electrically coupled to each other. Then, when the ink pouring device SV-q[m] and the ink bottle BT-q[m] are coupled to each other, the electrical signal indicating the bottle identification information DBI stored in the memory 56 is input to the input terminal 35 via the output terminal 55.

A shape of the coupling portion 30-q[m] described in FIGS. 2 to 6 is unique to the ink pouring device SV-q[m] among the plurality of ink pouring devices SV included in the ink management system Sys. That is, among the plurality of ink pouring devices SV included in the ink management system Sys, a coupling portion 30 provided in an ink pouring device SV different from the ink pouring device SV-q[m] has a shape different from that of the coupling portion 30-q[m]. Specifically, among M ink pouring devices SV provided in the ink storage device S-q, a coupling portion 30-q[m1] provided in an ink pouring device SV-q[m1] corresponding to the m1-th ink IK and a coupling portion 30-q[m2] provided in an ink pouring device SV-q[m2] corresponding to the m2-th ink IK have different shapes. Here, the variable m1 is a natural number satisfying 1≤m1×≤M, and the variable m2 is a natural number that is different from the variable m1 and satisfies 1≤m2≤M. In other words, M coupling portions 30-q[1] to 30-q[M] provided in the same ink storage device S-q have different shapes. A coupling portion 30-q1[m1] of an ink pouring device SV-q1[m1] provided in an ink storage device S-q1 and a coupling portion 30-q2[m1] of an ink pouring device SV-q2[m1] provided in an ink storage device S-q2 have different shapes. Here, the variable q1 is a natural number satisfying 1≤q1≤0, and the variable q2 is a natural number that is different from the variable q1 and satisfies 1≤q2≤Q. In other words, a plurality of coupling portions 30 arranged in different facilities FC have different shapes.

A shape of the coupling target portion 40-q[m] described in FIGS. 2 to 6 is unique to the ink bottle BT-q[m] among the plurality of ink bottles BT included in the ink management system Sys. That is, among the plurality of ink bottles BT included in the ink management system Sys, a coupling target portion 40 provided in an ink bottle BT different from the ink bottle BT-q[m] has a shape different from that of the coupling target portion 40-q[m].

Specifically, among M ink bottles BT provided in the facility FC-q, a coupling target portion 40-q[m1] provided in an ink bottle BT-q[m1] corresponding to the m1-th ink IK and a coupling target portion 40-q[m2] provided in an ink bottle BT-q[m2] corresponding to the m2-th ink IK have different shapes. In other words, M coupling target portions 40-q[1] to 40-q[M] provided in the same facility FC-q have different shapes. A coupling target portion 40-q1[m1] of an ink bottle BT-q1[m1] provided in a facility FC-q1 and a coupling target portion 40-q2[m1] of an ink bottle BT-q2[m1] provided in a facility FC-q2 have different shapes. In other words, a plurality of coupling target portions 40 provided in different facilities FC have different shapes.

In the present embodiment, the coupling portion 30-q[m] provided in the ink pouring device SV-q[m] can be fitted into only the coupling target portion 40-q[m] provided in the ink bottle BT-q[m] among the plurality of ink bottles BT included in the ink management system Sys, and cannot be fitted into a coupling target portion 40 provided in an ink bottle BT other than the ink bottle BT-q[m] among the plurality of ink bottles BT included in the ink management system Sys.

Specifically, the coupling target portion 40-q[m1] provided in the ink bottle BT-q[m1] corresponding to the m1-th ink IK among M ink bottles BT provided in the facility FC-q can be fitted into the coupling portion 30-q[m1] provided in the ink pouring device SV-q[m1] corresponding to the m1-th ink IK among M ink pouring devices SV provided in the ink storage device S-q, but the coupling target portion 40-q[m2] provided in the ink bottle BT-q[m2] corresponding to the m2-th ink IK among M ink bottles BT provided in the facility FC-q cannot be fitted into the coupling portion 30-q[m1]. Further, the coupling target portion 40-q1[m1] provided in the ink bottle BT-q1[m1] corresponding to the m1-th ink IK among M ink bottles BT provided in the facility FC-q1 can be fitted into the coupling portion 30-q1[m1] provided in the ink pouring device SV-q1[m1] corresponding to the m1-th ink IK among M ink pouring devices SV provided in the facility FC-q1, but the coupling target portion 40-q2[m1] provided in the ink bottle BT-q2[m1] corresponding to the m1-th ink IK among M ink bottles BT provided in the facility FC-q2 cannot be fitted into the coupling portion 30-q1[m1].

In the present embodiment, a shape of the coupled pouring portion CP-q[m] is unique to the ink tank TK-q[m] among the plurality of ink tanks TK included in the ink management system Sys. In the present embodiment, the coupled pouring portion CB-q[m] provided in the ink bottle BT-q[m] can be coupled to only the coupled pouring portion CP-q[m] provided in the ink tank TK-q[m] among the plurality of ink tanks TK included in the ink management system Sys, but cannot be coupled to a coupled pouring portion CP provided in an ink tank TK other than the ink tank TK-q[m] among the plurality of ink tanks TK included in the ink management system Sys.

In the present embodiment, a plurality of coupled pouring portions CP-q[m] of a plurality of ink tanks TK-q[m] corresponding to the m-th ink IK among the plurality of ink tanks TK included in the plurality of ink jet printers PR-q provided in the facility FC-q have a common shape. Specifically, the coupled pouring portion CP-q[m] provided in the ink tank TK-q[m] of the ink jet printer PR-q(1) and the coupled pouring portion CP-q[m] provided in the ink tank TK-q[m] of the ink jet printer PR-q(2) have a common shape. That is, in the present embodiment, the coupled pouring portion CB-q[m] provided in the ink bottle BT-q[m] can be coupled to both the coupled pouring portion CP-q[m] provided in the ink tank TK-q[m] of the ink jet printer PR-q(1) among the plurality of ink tanks TK included in the ink management system Sys, and the coupled pouring portion CP-q[m] provided in the ink tank TK-q[m] of the ink jet printer PR-q(2).

### 3. Overview of Control Device

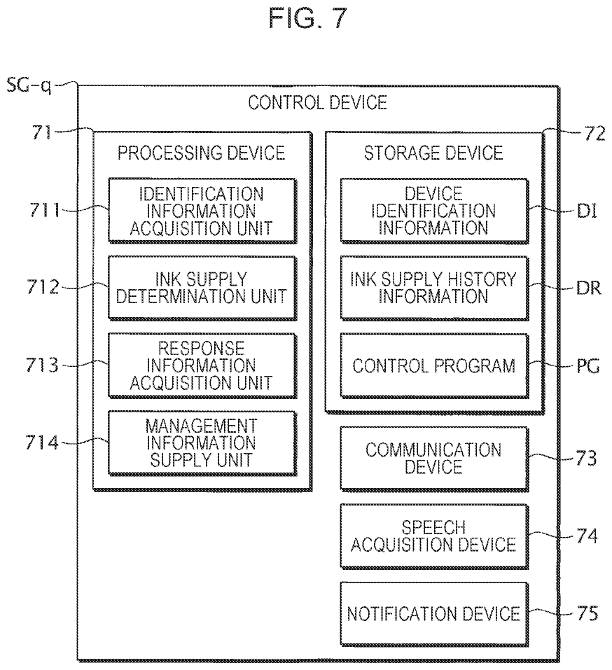

Hereinafter, an example of a configuration of the control device SG-q according to the present embodiment will be described with reference to FIG. 7.

FIG. 7 is a block diagram illustrating an example of the configuration of the control device SG-q.

As illustrated in FIG. 7, the control device SG-q includes a processing device 71, a storage device 72, a communication device 73, a speech acquisition device 74, and a notification device 75.

The communication device 73 is hardware for communicating with an external device such as the management server KS that is present outside the control device SG-q via the network NW.

The storage device 72 includes, for example, one or both of a volatile memory such as a random access memory (RAM) that functions as a work area for the processing device 71, and a non-volatile memory such as an electrically erasable programmable read-only memory (EEPROM) that stores various information.

The storage device 72 stores device identification information DI, the ink supply history information DR, and a control program PG for the ink storage device S-q.

The device identification information DI is information indicating the ink bottle BT-q[m] that can be coupled to the ink pouring device SV-q[m] included in the ink storage device S-q. Specifically, the device identification information DI is information in which M pieces of pouring device identification information DSI corresponding to M ink pouring devices SV-q[1] to SV-q[M] included in the ink storage device S-q are one-to-one associated with M pieces of bottle identification information DBI corresponding to M ink bottles BT-q[1] to BT-q[M] that can be coupled to the M ink pouring devices SV-q[1] to SV-q[M]. Here, the pouring device identification information DSI is information for identifying each ink pouring device SV-q[m] among the plurality of ink pouring devices SV included in the ink management system Sys.

The ink supply history information DR is information indicating the history of supply of the ink IK by each of M ink pouring devices SV-q[1] to SV-q[M] included in the ink storage device S-q. Specifically, the ink supply history information DR includes the pouring device identification information DSI corresponding to the ink pouring device SV-q[m] that supplied the ink IK among the M ink pouring devices SV-q[1] to SV-q[M] included in the ink storage device S-q, the bottle identification information DBI corresponding to the ink bottle BT-q[m] that received the ink IK from the ink pouring device SV-q[m], information indicating a date and time of supply of the ink IK by the ink pouring device SV-q[m], and information indicating the amount of supply of the ink IK by the ink pouring device SV-q[m]. The ink supply history information DR is an example of “ink related information”.

The processing device 71 includes a processor and controls each portion of the ink storage device S-q. The processor provided in the processing device 71 includes, for example, one or more central processing units (CPUs). Alternatively, the processor provided in the processing device 71 may include hardware such as a graphics processing unit (GPU), a digital signal processor (DSP), or a field programmable gate array (FPGA) in addition to one or more CPUs, or in place of some or all of the one or more CPUs.

The processor provided in the processing device 71 executes the control program PG stored in the storage device 72, and operates according to the control program PG to function as an identification information acquisition unit 711, an ink supply determination unit 712, a response information acquisition unit 713, and a management information supply unit 714.

When the ink bottle BT-q[m] is coupled to the ink pouring device SV-q[m], the identification information acquisition unit 711 acquires the bottle identification information DBI for identifying the ink bottle BT-q[m] from the memory 56 included in the ink bottle BT-q[m] via the input terminal 35 included in the ink pouring device SV-q[m] and the output terminal 55 included in the ink bottle BT-q[m].

The ink supply determination unit 712 determines whether or not the ink bottle BT coupled to the ink pouring device SV-q[m] is the ink bottle BT-q[m] corresponding to the ink pouring device SV-q[m] based on the bottle identification information DBI acquired by the identification information acquisition unit 711 and the device identification information DI stored in the storage device 72. That is, the ink supply determination unit 712 determines whether or not the bottle identification information DBI acquired from the ink bottle BT coupled to the ink pouring device SV-q[m] is the bottle identification information DBI corresponding to the pouring device identification information DSI that identifies the ink pouring device SV-q[m]. The ink supply determination unit 712 is an example of a “determination unit”.

Then, when a result of the determination by the ink supply determination unit 712 is affirmative, the processing device 71 controls the locking mechanism 23 in such a way that the locking mechanism 23 can unlock the ink pouring valve 22. When the result of the determination by the ink supply determination unit 712 is negative, the processing device 71 controls the locking mechanism 23 in such a way that the locking mechanism 23 locks the ink pouring valve 22.

The management information supply unit 714 supplies information such as the ink supply history information DR including the bottle identification information DBI to the management server KS. The management information supply unit 714 is an example of a “supply unit”.

The speech acquisition device 74 is, for example, a microphone, and acquires a speech of the user U-q. The management information supply unit 714 supplies, to the management server KS, speech information DUS indicating the speech of the user U-q acquired by the speech acquisition device 74.

In the present embodiment, the management server KS has a speech analysis function of analyzing the speech of the user U-q, and a response function of generating response information DUO indicating a response to the speech of the user U-q based on an analysis result obtained by the speech analysis function. The response information acquisition unit 713 acquires the response information DUO from the management server KS.

The notification device 75 is, for example, a speaker, and outputs a speech representing a response content indicated by the response information DUO acquired by the response information acquisition unit 713.

In the present embodiment, an aspect in which the speech analysis function and the response function are provided in the management server KS is described as an example, but the present disclosure is not limited to such an aspect. One or both of the speech analysis function and the response function may be provided in the control device SG-q.

In the present embodiment, an aspect in which the ink storage device S-q includes M ink pouring devices SV-q[1] to SV-q[M] and one control device SG-q is described as an example, but the present disclosure is not limited to such an aspect. The control device SG-q may be provided in each ink pouring device SV-q[m].

### 4. Conclusion of Embodiment

As described above, the ink pouring device SV-q[m] according to the present embodiment is the ink pouring device SV-q[m] that pours the ink IK into the ink bottle BT-q[m] for supplying the ink IK to the ink tank TK-q[m] provided in the ink jet printer PR-q, the ink pouring device SV-q[m] including the ink pouring portion 20 that can pour the ink IK into the ink bottle BT-q[m] only when the coupling target portion 40-q[m] of the ink bottle BT-q[m] is fitted into the coupling portion 30-q[m].

As described above, according to the present embodiment, the user U-q reuses the ink bottle BT-q[m] because only the ink bottle BT-q[m] including the coupling target portion 40-q[m] corresponding to the coupling portion 30-q[m] of the ink pouring device SV-q[m] is the ink bottle BT into which the ink pouring device SV-q[m] can pour the ink IK. In other words, according to the present embodiment, it is possible to reduce a possibility that the ink bottle BT is discarded as compared to an aspect in which the ink pouring device SV-q[m] can pour the ink IK into any ink bottle BT. Therefore, according to the present embodiment, it is possible to reduce a possibility that the ink bottle BT becomes waste to make a contribution to preventing and reducing waste generation and substantially reducing waste generation through reuse as described in target “12.5” of the sustainable development goals (SDGs) as compared to the aspect in which the ink pouring device SV-q[m] can pour the ink IK into any ink bottle BT. According to the present embodiment, only the ink bottle BT-q[m] is the ink bottle BT into which the ink pouring device SV-q[m] can pour the ink IK, and it is thus possible to reduce a possibility that the ink IK remaining in the ink bottle BT is discarded when the ink bottle BT is discarded as compared to the aspect in which the ink pouring device SV-q[m] can pour the ink IK into any ink bottle BT. Therefore, according to the present embodiment, it is possible to reduce a possibility that the ink IK becomes waste to make a contribution to implementing waste control and substantially reducing release of chemicals included in wastes to air, water, and soil as described in target “12.4” of the SDGs as compared to the aspect in which the ink pouring device SV-q[m] can pour the ink IK into any ink bottle BT. As described above, according to the present embodiment, it is possible to make a greater contribution to Goal 12 of the SDGs, which is to “ensure sustainable consumption and production patterns”, as compared to the aspect in which the ink pouring device SV-q[m] can pour the ink IK into any ink bottle BT.

According to the present embodiment, only the ink bottle BT-q[m] is the ink bottle BT into which the ink pouring device SV-q[m] can pour the ink IK, and it is thus possible to reduce a possibility that the ink IK in the ink bottle BT is discarded when the ink bottle BT is discarded as compared to the aspect in which the ink pouring device SV-q[m] can pour the ink IK into any ink bottle BT. That is, according to the present embodiment, it is possible to reduce a possibility that the ink IK becomes waste to make a contribution to substantially reducing the number of deaths and illnesses from wastes such as chemicals and air, water, and soil pollution and contamination as described in target “3.9” of the SDGs as compared to the aspect in which the ink pouring device SV-q[m] can pour the ink IK into any ink bottle BT. As described above, according to the present embodiment, it is possible to make a greater contribution to Goal 3 of the SDGs, which is to “ensure healthy lives and promote well-being for all at all ages”, as compared to the aspect in which the ink pouring device SV-q[m] can pour the ink IK into any ink bottle BT.

According to the present embodiment, only the ink bottle BT-q[m] is the ink bottle BT into which the ink pouring device SV-q[m] can pour the ink IK, and it is thus possible to reduce a possibility that the ink bottle BT and the ink IK in the ink bottle BT are easily discarded as compared to the aspect in which the ink pouring device SV-q[m] can pour the ink IK into any ink bottle BT. That is, according to the present embodiment, it is possible to reduce a possibility that the ink bottle BT and the ink IK become waste to pay special attention to waste control and reduce the adverse per capita environmental impact of cities as described in target “11.6” of the SDGs as compared to the aspect in which the ink pouring device SV-q[m] can pour the ink IK into any ink bottle BT. As described above, according to the present embodiment, it is possible to make a greater contribution to Goal 11 of the SDGs, which is to “make cities and human settlements inclusive, safe, resilient, and sustainable”, as compared to the aspect in which the ink pouring device SV-q[m] can pour the ink IK into any ink bottle BT.

According to the present embodiment, only the ink bottle BT-q[m] is the ink bottle BT into which the ink pouring device SV-q[m] can pour the ink IK, and it is thus possible to reduce a possibility that disabled or elderly people such as the user U-q with low vision and the user U-q with limited finger mobility mistakenly pour the ink IK into an ink bottle BT into which the ink IK originally cannot be poured, as compared to the aspect in which the ink pouring device SV-q[m] can pour the ink IK into any ink bottle BT. In other words, according to the present embodiment, it is possible to empower and promote the social, economic and political inclusion of all, irrespective of age, sex, disability, race, ethnicity, origin, religion or economic or other status as described in target “10.2” of the SDGs as compared to the aspect in which the ink pouring device SV-q[m] can pour the ink IK into any ink bottle BT. As described above, according to the present embodiment, it is possible to make a greater contribution to Goal 10 of the SDGs, which is to “reduce income inequality within and among countries”, as compared to the aspect in which the ink pouring device SV-q[m] can pour the ink IK into any ink bottle BT.

Further, in the present embodiment, the coupling portion 30-q[m] includes the coupling structure 31-q[m] and the coupling structure 32-q[m], the ink pouring portion 20 includes the ink supply channel 21 through which the ink IK is supplied from the ink accommodation portion 10 that accommodates the ink IK to the ink bottle BT-q[m] when the coupling target portion 40-q[m] is fitted into the coupling portion 30-q[m], and the ink supply channel 21 is positioned between the coupling structure 31-q[m] and the coupling structure 32-q[m].

As described above, according to the present embodiment, the ink supply channel 21 is provided between the coupling structure 31-q[m] and the coupling structure 32-q[m], and it is thus possible to reduce a risk that the user U-q with low vision or the user U-q with limited finger mobility touches the ink supply channel 21 as compared to an aspect in which the coupling structure 31-q[m] and the coupling structure 32-q[m] are not provided around the ink supply channel 21. That is, according to the present embodiment, it is possible to reduce a risk that disabled or elderly people get their fingertips dirty by touching the ink IK as compared to the aspect in which the coupling structure 31-q[m] and the coupling structure 32-q[m] are not provided around the ink supply channel 21. In other words, according to the present embodiment, it is possible to empower and promote the social, economic and political inclusion of all, irrespective of age, sex, disability, race, ethnicity, origin, religion or economic or other status as described in target “10.2” of the SDGs as compared to the aspect in which the coupling structure 31-q[m] and the coupling structure 32-q[m] are not provided around the ink supply channel 21. As described above, according to the present embodiment, it is possible to make a greater contribution to Goal 10 of the SDGs, which is to “reduce income inequality within and among countries”, as compared to the aspect in which the coupling structure 31-q[m] and the coupling structure 32-q[m] are not provided around the ink supply channel 21.

In the present embodiment, the ink pouring device SV-q[m] may include the identification information acquisition unit 711 that acquires the bottle identification information DBI from the memory 56 that is provided in the ink bottle BT-q[m] and stores the bottle identification information DBI for identifying the ink bottle BT-q[m], and the ink supply determination unit 712 that determines whether or not the ink IK can be poured from the ink pouring portion 20 into the ink bottle BT-q[m] based on the bottle identification information DBI acquired by the identification information acquisition unit 711.

Therefore, according to the present embodiment, it is possible to prevent the ink IK from being poured from the ink pouring device SV-q[m] into an ink bottle BT other than the ink bottle BT-q[m] when the ink bottle BT is forcibly coupled to the ink pouring device SV-q[m] by for example, destroying the coupling portion 30-q[m].

In the present embodiment, the ink pouring device SV-q[m] includes input terminal 35 for inputting information, and the identification information acquisition unit 711 acquires the bottle identification information DBI via the output terminal 55 provided in the ink bottle BT-q[m] and the input terminal 35 coupled to the output terminal 55.

In the present embodiment, the identification information acquisition unit 711 provided in the ink pouring device SV-q[m] acquires the bottle identification information DBI from the memory 56 provided in the ink bottle BT-q[m] via the input terminal 35 and the output terminal 55, but the present disclosure is not limited to such an aspect. For example, the identification information acquisition unit 711 provided in the ink pouring device SV-q[m] may acquire the bottle identification information DBI from the memory 56 provided in the ink bottle BT-q[m] through communication via the communication device 73. In this case, the ink bottle BT-q[m] may be provided with a bottle-side communication device that is a communication device for performing communication. That is, the identification information acquisition unit 711 provided in the ink pouring device SV-q[m] acquires the bottle identification information DBI via the bottle-side communication device provided in the ink bottle BT-q[m] and the communication device 73.

In the present embodiment, the ink pouring device SV-q[m] may include the management information supply unit 714 that supplies, to the management server KS that manages the ink pouring device SV-q[m], the bottle identification information DBI for identifying the ink bottle BT-q[m] into which the ink IK is poured by the ink pouring device SV-q[m].

Therefore, according to the present embodiment, it is possible to grasp the status of the ink bottle BT used in the ink management system Sys.

In the present embodiment, the ink pouring device SV-q[m] may include the management information supply unit 714 that supplies, to the management server KS that manages the ink pouring device SV-q[m], the ink supply history information DR related to the ink IK accommodated in the ink pouring device SV-q[m].

Therefore, according to the present embodiment, it is possible to grasp the use status of the ink IK accommodated in the ink pouring device SV-q[m] and the remaining amount of the ink IK accommodated in the ink pouring device SV-q[m].

In the present embodiment, the ink pouring device SV-q[m] may include the speech acquisition device 74 that acquires a speech of the user U-q, and the notification device 75 that notifies the user U-q of a response to the speech of the user U-q acquired by the speech acquisition device 74.

Therefore, according to the present embodiment, the convenience for the user U-q is improved as compared to an aspect in which the ink pouring device SV-q[m] does not include the speech acquisition device 74 and the notification device 75.

In the present embodiment, the ink pouring device SV-q[m] may include the management information supply unit 714 that supplies, to the management server KS that analyses a speech of the user U-q and generates the response information DUO indicating a response to the speech of the user U-q based on a result of the analysis, the speech information DUS indicating the speech of user U-q acquired by the speech acquisition device 74, and the response information acquisition unit 713 that acquires the response information DUO generated by the management server KS from the management server KS, in which the notification device 75 may notify the user U-q of a speech based on the response information DUO acquired by the response information acquisition unit 713.

### B. MODIFIED EXAMPLES

Each embodiment described above can be modified in various ways. Specific aspects of the modification are described below. Two or more aspects arbitrarily selected from the following examples can be appropriately and compatibly combined. In the modified example described below, the reference numerals referred to in the above description will be used for elements whose actions and functions are equivalent to those in the embodiment, and a detailed description thereof will be omitted as appropriate.

### First Modified Example

Although the aspect in which the coupling portion 30-q[m] includes the coupling structure 31-q[m] and the coupling structure 32-q[m] has been described as an example in the above-described embodiment, the present disclosure is not limited to such an aspect. Although the aspect in which the coupling target portion 40-q[m] includes the coupling structure 41-q[m] and the coupling structure 42-q[m] has been described as an example in the above-described embodiment, the present disclosure is not limited to such an aspect.

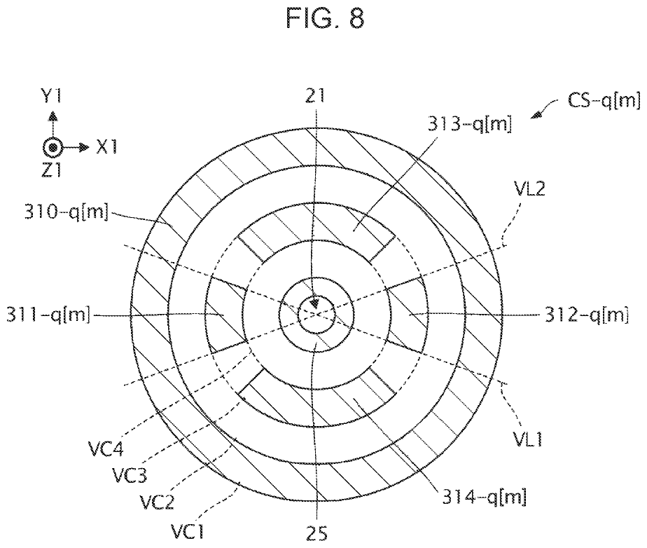

FIG. 8 is a cross-sectional view of a coupled pouring portion CS-q[m] taken along line III-III of FIG. 2 when the coupled pouring portion CS-q[m] is cut along a plane whose normal direction is the Z-axis direction.

As illustrated in FIG. 8, in this modified example, a coupling portion 30-q[m] provided in the coupled pouring portion CS-q[m] includes an annular structure 310-q[m] provided to surround a channel structure 25 that forms an ink supply channel 21, and a coupling structure 311-q[m], a coupling structure 312-q[m], a coupling structure 313-q[m], and a coupling structure 314-q[m] provided between the channel structure 25 and the annular structure 310-q[m].

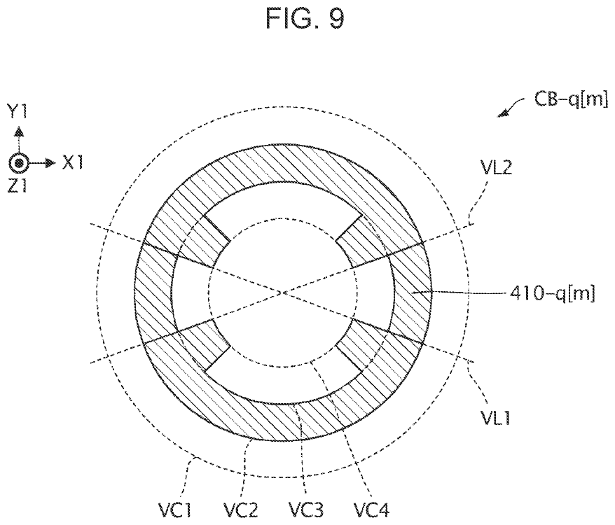

FIG. 9 is a cross-sectional view of a coupled pouring portion CB-q[m] taken along line V-V of FIG. 4 when the coupled pouring portion CB-q[m] is cut along a plane whose normal direction is the Z-axis direction.

As illustrated in FIG. 9, in this modified example, a coupling target portion 40-q[m] provided in the coupled pouring portion CB-q[m] includes an annular structure 410-q[m] having a shape that can be fitted into the coupling portion 30-q[m]. The annular structure 410-q[m] surrounds the channel structure 25 that forms the ink supply channel 21 when an ink bottle BT-q[m] is coupled to an ink pouring device SV-q[m].

As described above, in the ink pouring device SV-q[m] according to this modified example, the coupling portion 30-q[m] includes the annular structure 310-q[m] having an annular shape, an ink pouring portion 20 includes the ink supply channel 21 through which the ink IK is supplied from an ink accommodation portion 10 that accommodates the ink IK to the ink bottle BT-q[m] when the coupling target portion 40-q[m] is fitted into the coupling portion 30-q[m], and the ink supply channel 21 is arranged in such a way as to be surrounded by the annular structure 310-q[m].

As described above, according to this modified example, the ink supply channel 21 is surrounded by the annular structure 310-q[m], and it is this possible to reduce a risk that the user U-q touches the ink supply channel 21 as compared to an aspect in which the annular structure 310-q[m] is not provided around the ink supply channel 21. That is, according to this modified example, it is possible to reduce a risk that disabled or elderly people get their fingertips dirty by touching the ink IK as compared to the aspect in which the annular structure 310-q[m] is not provided around the ink supply channel 21. In other words, according to this modified example, it is possible to empower and promote the social, economic and political inclusion of all, irrespective of age, sex, disability, race, ethnicity, origin, religion or economic or other status as described in target “10.2” of the SDGs as compared to the aspect in which the annular structure 310-q[m] is not provided around the ink supply channel 21. As described above, according to the present embodiment, it is possible to make a greater contribution to Goal 10 of the SDGs, which is to “reduce income inequality within and among countries”, as compared to the aspect in which the annular structure 310-q[m] is not provided around the ink supply channel 21.

### Second Modified Example

Although the aspect in which the ink management system Sys includes the management server KS has been described as an example in the above-described embodiment and the first modified example, the present disclosure is not limited to such an aspect. The ink management system Sys does not have to include the management server KS. In this case, the control device SG-q does not have to include the communication device 73.

### Third Modified Example

Although the aspect in which the ink storage device S-q includes the control device SG-q has been described as an example in the above-described embodiment and the first and second modified examples, the present disclosure is not limited to such an aspect. The ink storage device S-q does not have to include the control device SG-q.

Although the aspect in which the ink pouring device SV-q[m] includes the input terminal 35 has been described as an example in the above-described embodiment and the first and second modified examples, the present disclosure is not limited to such an aspect. The ink pouring device SV-q[m] does not have to include the input terminal 35.

Although the aspect in which the ink bottle BT-q[m] includes the output terminal 55 and the memory 56 has been described as an example in the above-described embodiment and the first and second modified examples, the present disclosure is not limited to such an aspect. The ink bottle BT-q[m] does not have to include the output terminal 55 and the memory 56.

What is claimed is:

1. An ink pouring device that pours ink into an ink bottle for supplying the ink to an ink tank provided in a printer, the ink pouring device comprising:
a coupling portion; and
a pouring portion configured to pour the ink into the ink bottle only when a coupling target portion of the ink bottle is fitted into the coupling portion.

2. The ink pouring device according to claim 1, wherein
the coupling portion includes a first structure and a second structure,
the pouring portion includes a supply channel through which the ink is supplied from an accommodation portion that accommodates the ink to the ink bottle when the coupling target portion is fitted into the coupling portion, and
the supply channel is positioned between the first structure and the second structure.

3. The ink pouring device according to claim 1, wherein
the coupling portion includes an annular structure having an annular shape,
the pouring portion includes a supply channel through which the ink is supplied from an accommodation portion that accommodates the ink to the ink bottle when the coupling target portion is fitted into the coupling portion, and
the supply channel is arranged in such a way as to be surrounded by the annular structure.

4. The ink pouring device according to claim 1, further comprising:
an identification information acquisition unit that acquires identification information for identifying the ink bottle from a memory that is provided in the ink bottle and stores the identification information; and
a determination unit that determines whether or not the ink is pourable from the pouring portion into the ink bottle based on the identification information acquired by the identification information acquisition unit.

5. The ink pouring device according to claim 4, further comprising an input terminal for inputting information, wherein
the identification information acquisition unit acquires the identification information via an output terminal provided in the ink bottle and the input terminal coupled to the output terminal.

6. The ink pouring device according to claim 4, further comprising a communication device for performing communication, wherein
the identification information acquisition unit acquires the identification information via a bottle-side communication device provided in the ink bottle and the communication device.

7. The ink pouring device according to claim 1, further comprising a supply unit that supplies identification information for identifying the ink bottle into which the ink is poured by the ink pouring device to a management device that manages the ink pouring device.

8. The ink pouring device according to claim 1, further comprising a supply unit that supplies ink related information related to the ink accommodated in the ink pouring device to a management device that manages the ink pouring device.

9. The ink pouring device according to claim 1, further comprising:
a speech acquisition device that acquires a speech of a user; and
a notification device that notifies the user of a response to the speech of the user acquired by the speech acquisition device.

10. The ink pouring device according to claim 9, further comprising:
a supply unit that supplies speech information indicating the speech of the user acquired by the speech acquisition device to a management device that analyzes the speech of the user and generates response information indicating the response to the speech of the user based on a result of the analysis; and
a response information acquisition unit that acquires the response information generated by the management device from the management device, wherein
the notification device notifies the user of a speech based on the response information acquired by the response information acquisition unit.
